(19) United States
(12) Patent Application Publication
(10) Pub. No.: US 2009/0324898 A1
(43) Pub. Date: Dec. 31, 2009

(54) ACCOUTERMENT HAVING THERMAL TRANSFER PRINTING PATTERNS

(76) Inventor: Kuo-Hua CHU, Taipei (TW)

Correspondence Address: BIRCH STEWART KOLASCH & BIRCH, PO BOX 747, FALLS CHURCH, VA, 22040-0747, US

(21) Appl. No.: 12/146,168

(22) Filed: Jun. 25, 2008

(51) Int. Cl. G03G 8/00

(52) U.S. Cl. 428/195.1

(57) ABSTRACT

An accouterment having patterns printed by thermal transfer printing process is provided. The present invention sticks transfer printing layers having patterns or traceries pre-printed thereon onto an inside surface and an outside surface of an accouterment to transfer the patterns onto the accouterment. The patterns are then spray coated with a layer of glossy paint. Such a layer of glossy paint makes the patterns achieving stereoscopic effect. And when the accouterment endures a light refraction, the patterns on the inside surface and the outside surface of the accouterment are visually overlapped one to another so as to generate a stereoscopic impression.

### BACKGROUND OF THE INVENTION

1. Field of the Invention

The present invention relates generally to an accouterment having patterns printed by thermal transfer printing process at an inside and an outside thereof, respectively, so that the patterns printed at the inside and the outside of the accouterment achieve a stereoscopic effect through light refraction.

2. The Prior Arts

Modern people follow the fashion. Therefore, they are used to wear accouterments to match with the garments. Often selected accouterments include spectacle, necklaces, bracelets, hair accessories, earrings, and the like. There are great varieties of accouterments on sale in the market. For the purpose of developing more popular products and obtaining more shares from the market, many accouterment manufacturers are dedicated to improve appearance design of their products for attracting interest of more customers. Ordinary approaches for modifying appearance of an accouterment product includes: sticking a sticker having a pattern to the product; mounting glossy beads thereto; preparing a paper form having a pattern and configuring the pattern onto the product by spraying paint thereto, etc. However, after being worn for a certain time, the products finished with the aforementioned approaches often lose decoration, because of damage of sticker or paint, or drop-off of beads. As such, a more reliable approach for decorating accouterments is highly desired.

Thermal transfer printing has been widely used for decorating apparels, fashion accessories, ceramics, can vessels, or the like. Taking a can vessel as an example, when performing a thermal transfer printing, a thermal transfer printer conducts a thermal press to a thermal transfer printing ribbon having characters pre-printed thereon, so that the can vessel positioned under the thermal transfer printing ribbon is pressed at the same time. In such a way, the characters on the thermal transfer printing ribbon can be transferred to a surface of the can vessel. Such transferred characters are firm, stereoscopic, and convenient for printing small patterns. The present invention applies the thermal transfer printing process in printing decorative patterns onto accouterments for adding more fashion elements thereto.

### SUMMARY OF THE INVENTION

A primary objective of the present invention is to print patterns onto an inside surface and an outside surface of an accouterment, and spray coat a layer of glossy paint onto the patterns. In such a way, the patterns achieve stereoscopic effect. Or, when the accouterment endures a light refraction, the patterns on the inside surface and the outside surface of the accouterment are looked overlapped one to another so as to generate a stereoscopic impression.

For achieving the foregoing objective, the present invention sticks transfer printing layers (or transfer printing films) having patterns or traceries pre-printed thereon onto an inside surface and an outside surface of an accouterment (e.g., a spectacle, a waistband, an earring . . . ). Preferably, the patterns respectively pre-printed on the transfer printing layers of the inside surface and the outside surface are echoed one to another. For example, the pattern pre-printed on the transfer printing layer stuck to the inside surface includes many birds, while the pattern pre-printed on the transfer printing layer stuck to the outside surface includes many trees. After vertically thermal pressing the transfer printing layers to the inside surface and the outside surface of the accouterment with the thermal transfer printer, and peeling off the transfer printing layers from the accouterment later, the patterns or the traceries are then transfer printed onto the accouterment.

The patterns are then spray coated with a layer of glossy paint. Such a layer of glossy paint makes the patterns achieving stereoscopic effect. And when the accouterment endures a light refraction, the patterns on the inside surface and the outside surface of the accouterment are looked overlapped one to another so as to generate a stereoscopic impression, i.e., birds flying through or staying in the trees.

Comparing with the conventional technologies, e.g., sticking stickers, or spraying paint onto a spectacle frame, the patterns obtained by thermal transfer printing in accordance with the present invention are firmer, and do not have the difficulty of messy patterns. Further, the patterns are adapted for achieving the aforementioned stereoscopic effect, so as to make the accouterment looked more adorable for attracting prospective consumers to buy.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view illustrating thermal transfer printing on a surface of a spectacle frame according to an embodiment of the present invention;

FIG. 2 is a schematic view illustrating spray coating glossy paint on the surface of the spectacle frame according to an embodiment of the present invention; and

FIG. 3 is a schematic view illustrating thermal transfer printing patterns printed on the surface of the spectacle frame according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

The present invention is adapted for transfer printing firm patterns on an inside surface and an outside surface of an accouterment or accessory by thermal transfer printing, so as to improve the adorability and for attracting more prospective consumers to buy the product. The present invention is exemplified with but not restricted to be a spectacle. In other embodiments, the accouterment can be a hair accessory, an earring, a waistband, or the like.

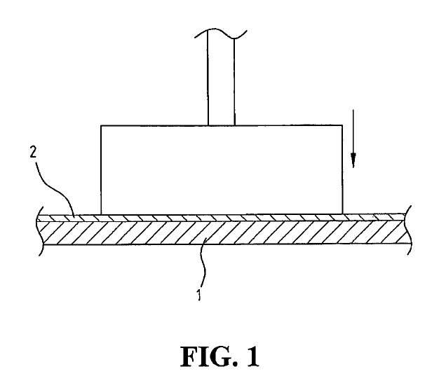

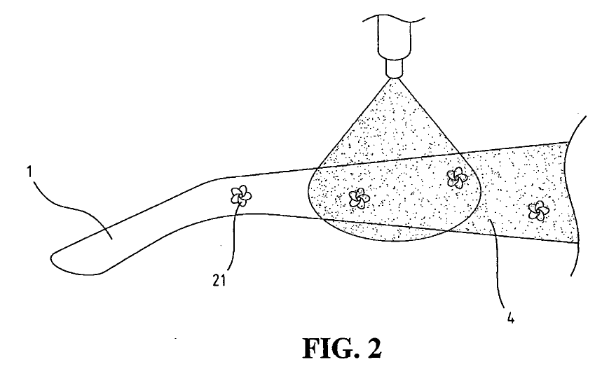

FIG. 1 is a schematic view illustrating thermal transfer printing on a surface of a spectacle frame according to an embodiment of the present invention. Referring to FIG. 1, thermal transfer printing layers 2 are attached to an inside surface and an outside surface of a spectacle frame 1, respectively. The thermal transfer printing layers 2 include patterns pre-printed thereon. Further, the patterns of the thermal transfer printing layers 2 attached respectively to the inside surface and the outside surface of the spectacle frame 1 are echoed one to another. For example, the pattern printed on the transfer printing layer 2 attached to the inside surface includes flowers, while the pattern printed on the transfer printing layer 2 attached to the outside surface includes butterflies; or the pattern printed on the transfer printing layer 2 attached to the inside surface includes ducklings, while the pattern printed on the transfer printing layer 2 attached to the outside surface includes a creek. After attaching the thermal transfer printing layer 2 to the inside surface and the outside surface of the spectacle frame 1, a thermal transfer printer is used to perpendicularly heat the inside surface and the outside surface of the spectacle frame 1. After thermal pressing, the thermal transfer printing layers 2 are peeled off from the inside surface and the outside surface of the spectacle frame 1. In such a way, the patterns are then transferred to the surfaces of the spectacle frame 1. Then, as shown in FIG. 2, a layer of glossy paint 4 is spray coated onto the inside surface and the outside surface of the spectacle frame 1, as well as the patterns 21, to complete the process.

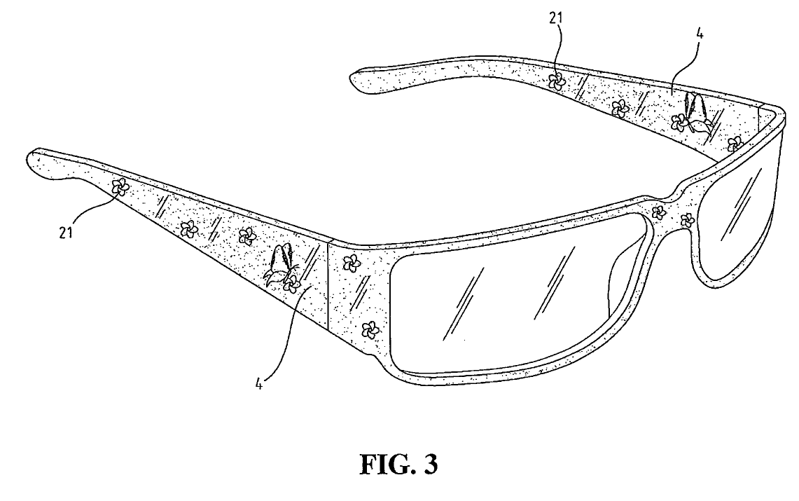

FIG. 3 is a schematic view illustrating thermal transfer printing patterns printed on the surface of the spectacle frame according to an embodiment of the present invention. Referring to FIG. 3, the provision of the layer of glossy paint 4 spray coated on the inside surface and the outside surface of the spectacle frame 1 makes the patterns achieving a stereoscopic effect. And further, when the spectacle frame 1 endures a light refraction, the patterns on the inside surface and the outside surface of the spectacle frame 1 are visually overlapped one to another so as to generate a stereoscopic impression. As shown in FIG. 3, patterns 21 including butterflies are configured on the outside surface of the spectacle frame 1, and patterns 21 including flowers are configured on the inside surface of the spectacle frame 1. When a light refraction is applied on the spectacle frame 1, a stereoscopic effect of butterflies flying in flowers can be visually achieved. In such a way, the spectacle frame 1 looks more elegant and attractive to those prospective consumers. However, it should be noted that the content of the patterns is not restricted by the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An accouterment having thermal transfer printing patterns, comprising:
a first thermal transfer printing pattern configured at an inside surface of the accouterment;
a second thermal transfer printing pattern configured at an outside surface of the accouterment;
a layer of glossy paint spray coated on the inside surface and the outside surface covering the first thermal transfer printing pattern, and the second thermal transfer printing pattern,
wherein the first thermal transfer printing pattern and the second thermal transfer printing pattern are adapted for echoing one to another, so that when enduring a light refraction, the first thermal transfer printing pattern and the second thermal transfer printing pattern are visually overlapped each other, and thus achieving a stereoscopic effect.

2. The accouterment having thermal transfer printing patterns according to claim 1, wherein the accouterment is a spectacle.

3. The accouterment having thermal transfer printing patterns according to claim 1, wherein the accouterment is a hair accessory.

4. The accouterment having thermal transfer printing patterns according to claim 1, wherein the accouterment is a fashion accessory.
